(19) United States
(12) Patent Application Publication
(10) Pub. No.: US 2015/0261424 A1
(43) Pub. Date: Sep. 17, 2015

(54) Tablet Transition Screens

(71) Applicant: Robb Fujioka, Manhattan Beach, CA (US)

(72) Inventor: Robb Fujioka, Manhattan Beach, CA (US)

(73) Assignee: Fuhu Holdings, Inc., El Segundo, CA (US)

(21) Appl. No.: 14/210,647

(22) Filed: Mar. 14, 2014

(51) Int. Cl. G06F 3/0484; G06F 3/0482; G06F 3/16

(52) U.S. Cl. CPC G06F 3/04847; G06F 3/165; G06F 3/04842; G06F 3/0482

(57) ABSTRACT

An apparatus and method are provided for a tablet computer system to entertain an end-user during otherwise boring periods while background operations are performed by the tablet computer. The tablet computer comprises navigation controls, a display screen, and an operating system that enables the end-user to interact with the operating system. Transition screens stored on the tablet computer are configured to display interesting images, animated sequences, and text on the display screen. Audio soundtracks corresponding to the content of the transition screens are configured to be played by way of loudspeakers of the tablet computer. In one embodiment, the transition screen is an animated skit performed by a cartoon character, and the relevant text and audio are popular slogans spoken by the cartoon character. Another embodiment of the transition screen is an animation of a famous actor accompanied by well known sayings attributed to the actor.

### FIELD OF THE INVENTION

The field of the invention generally relates to tablet computer systems. More particularly, the field of the invention relates to an apparatus and a method for a tablet computer system comprising transition screens to entertain an end-user during otherwise boring periods while background operations are performed by the tablet computer.

### BACKGROUND

Tablet computer typically include an interactive display screen, such as a touch screen, one or more navigation controls, and options provided by a software operating system to enable the end-user to interact with the operating system, and thus to use the tablet computer productively. While the end-user is interacting with the tablet computer, the operating system software performs a wide variety of continual background operations that are not directly observable to the end-user. Often times, these background operations require extensive quantities of computer memory, require a sharing of CPU cycles, or may cause a conflict in the use of shared resources, all of which potentially causing the computer to become unresponsive to the end-user's input. Many of these background operations occur at predetermined time periods, during which periods the end-user is presented with an icon, or other similar symbol such as an hourglass, which indicates that the end-user must wait for the background operations to finish before proceeding to further use the tablet computer. For some end-users, these time periods can be problematic. In the case of tablet computers that are intended for younger end-users, such as a child, for example, when the hourglass or other symbol appears for more than a few seconds, the child may become quickly bored with the tablet computer, put down the tablet computer, and then move on to other activities. What is needed, therefore, is a tablet computer that provides interesting content to end-users, such as young children, so to keep the end-users interested in the tablet computer during otherwise boring periods during which the tablet computer performs background operations and/or calculations.

### SUMMARY

The present invention describes an apparatus and a method for a tablet computer system to convey information to an end-user about background operations being performed by the tablet computer. The tablet computer comprises navigation controls and a non-transitory machine-readable storage medium that stores instructions, which when executed by the machine causes the machine to perform operations according to the instructions. An operating system stored on the non-transitory machine-readable storage medium enables the end-user to interact, with the operating system by way of options provided by the operating system and by way of the navigation controls. Transition screens stored on the non-transitory machine-readable storage medium are each configured to display symbolic imagery and relevant words on a display screen at predetermined times during operation of the tablet computer. The symbolic imagery and the words convey interesting information to the end-user about background operations being performed by the operating system. Audio soundtracks corresponding to the symbolic imagery and words on the display screen are configured to be played by way of loudspeakers of the tablet computer. The symbolic imagery may be a still image or an animated sequence which is context sensitive, where the context may be the operating environment, related operations, or even user settable. The symbolic imagery, the relevant words, and the audio soundtracks preferably share a common theme. For instance, the symbolic imagery may be an animated skit performed by a cartoon character, and the relevant words may be popular slogans or comments that are associated with the cartoon character. In another example, the transition screen may display an animation of a popular movie actor accompanied by well known sayings associated with the actor. It will be appreciated by those skilled in the art that an animated cartoon character and animated text advantageously serves to keep children interested in the tablet computer during otherwise boring periods during which the tablet computer and/or the operating system performs background operations.

In an exemplary embodiment, a tablet computer system comprises a tablet computer comprising one or more navigation controls and a non-transitory machine-readable storage medium that stores instructions, which when executed by the machine causes the machine to perform operations according to the instructions, an operating system comprising instructions that enable an end-user to interact with the operating system by way of the one or more navigation controls, wherein at least a portion of the operating system is stored on the non-transitory machine-readable storage medium, at least one transition screen which is stored on the non-transitory machine-readable storage medium, a display screen configured to display the at least one transition screen at predetermined times during operation of the tablet computer, and one or more loudspeakers configured to play audio soundtracks at predetermined times during operation of the tablet computer.

In another exemplary embodiment, the predetermined times are selected so as to entertain the end-user while other operations are performed by the operating system. In another exemplary embodiment, the at least one transition screen comprises a software portion of the operating system. In another exemplary embodiment, the at least one transition screen comprises a software program which is installed onto the tablet computer in addition to the operating system. In another exemplary embodiment, the at least one transition screen is implemented as a portion of an internal hardware configuration of the tablet computer.

In another exemplary embodiment, each of the at least one transition screen further comprises a symbolic descriptor configured to display symbolic imagery on the display screen and a text descriptor configured to display words on the display screen. In another exemplary embodiment, the symbolic descriptor is a still image which is relevant to background operations being performed by the operating system. In another exemplary embodiment, the symbolic descriptor is a logo, an image of a popular sports personality, a picture of a famous movie star, a cartoon character, or any other similar image suitable for displaying on the display screen. In another exemplary embodiment, the symbolic descriptor and the text descriptor share a common theme. In another exemplary embodiment, the symbolic descriptor is a cartoon character and the text descriptor comprises popular slogans or comments that are associated with the cartoon character. In another exemplary embodiment, the symbolic descriptor is a movie actor and the text descriptor comprises well known sayings associated with the actor.

In another exemplary embodiment, the symbolic descriptor is an animated sequence which conveys information to the end-user in an interesting manner about the background operations being performed by the operating system. In another exemplary embodiment, the tablet computer system is designed for children of a specific age group, wherein the symbolic descriptor is an animated sequence of a popular cartoon character performing a skit, and wherein the text descriptor comprises relevant words to accompany the symbolic descriptor. In another exemplary embodiment, the text descriptor is animated in addition to the symbolic descriptor, and the text descriptor moves according to the animated sequence comprising the symbolic descriptor. In another exemplary embodiment, the letters comprising the text descriptor change size, shape, color, order, orientation, or other similar attributes, according to the animation comprising the symbolic descriptor.

In another exemplary embodiment, the tablet computer system plays audio soundtracks, by way of the one or more loudspeakers, which shares the common theme with the symbolic descriptor and the text descriptor. In another exemplary embodiment, the symbolic descriptor and the one or more loudspeakers are synchronized such that the animated cartoon character appears to be saying the words played over the one or more loudspeakers.

In an exemplary embodiment, a method of providing a tablet computer system to an end-user comprises providing a tablet computer comprising one or more navigation controls and a non-transitory machine-readable storage medium that stores instructions, which when executed by the machine causes the machine to perform operations according to the instructions, storing an operating system onto the non-transitory machine-readable storage medium, wherein the operating system contains instructions that enable the end-user to interact with the operating system by way of options provided by the operating system and by way of the one or more navigation controls, storing at least one transition screen on the non-transitory machine-readable storage medium, displaying the at least one transition screen on the display screen at predetermined times during operation of the tablet computer, and configuring one or more loudspeakers to play audio soundtracks at predetermined times during operation of the tablet computer.

In another exemplary embodiment, the at least one transition screen comprises a software portion of the operating system, or comprises a software program which is installed onto the tablet computer in addition to the operating system. In another exemplary embodiment, the method of providing a tablet computer system to an end-user further comprising configuring each of the at least one transition screens to display symbolic imagery and relevant words on the display screen, wherein the symbolic imagery and the words convey interesting information to the end-user while background operations are being performed by the operating system.

### BRIEF DESCRIPTION OF THE DRAWINGS

The drawings refer to embodiments of the present invention in which:

FIG. 1 illustrates a front view of an exemplary embodiment of a tablet computer system in accordance with the present invention;

FIG. 2 illustrates a left side view of an exemplary embodiment of a tablet computer system in according to the present invention;

FIG. 3 illustrates an exemplary embodiment of a transition screen displayed on a tablet computer system intended for children of a specific age group according to the present invention; and

FIG. 4 illustrates an exemplary embodiment of a transition screen displayed on a tablet computer system intended for children of a specific age group in accordance with the present invention.

While the present invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present invention.

### DETAILED DISCUSSION

In the following description, numerous specific details are set forth, such as examples, in order to provide a thorough understanding of the present invention. It will be apparent, however, to one of ordinary skill in the art that the present invention may be practiced without these specific details. Further specific numeric references such as “a first opening,” may be made. However, the specific numeric reference should not be interpreted as a literal sequential order but rather interpreted that the “first opening” is different than a “second opening.” Thus, the specific details set forth are merely exemplary. The specific details may be varied from and still be contemplated to be within the spirit and scope of the present invention.

In general, the present invention describes an apparatus and a method for a tablet computer system to convey information to an end-user about background operations being performed by the tablet computer. The tablet computer comprises navigation controls and a software operating system that enables the end-user to interact with the operating system by way of options provided by the operating system and by way of the navigation controls. Transition screens stored on a storage medium of the tablet computer are each configured to display symbolic imagery and relevant text, or words, on a display screen at predetermined times, and for predetermined durations, during operation of the tablet computer. The transition screens convey context sensitive information to the end-user in an interesting manner about background operations being performed by the operating system, related operations, or may be user settable. The transition screens may comprise still images or animated sequences that are relevant to the operations being performed by the operating system. Audio soundtracks corresponding to the content of the transition screens are configured to be played by way of loudspeakers of the tablet computer. Preferably, the content of the transition screens and the audio soundtracks share a common theme. For example, the transition screen may be comprised of an image or an animated skit performed by a cartoon character, and the relevant text may be popular slogans or comments that are associated with the cartoon character. Similarly, the transition screen may display an animation of a famous actor accompanied by well known sayings attributed to the actor.

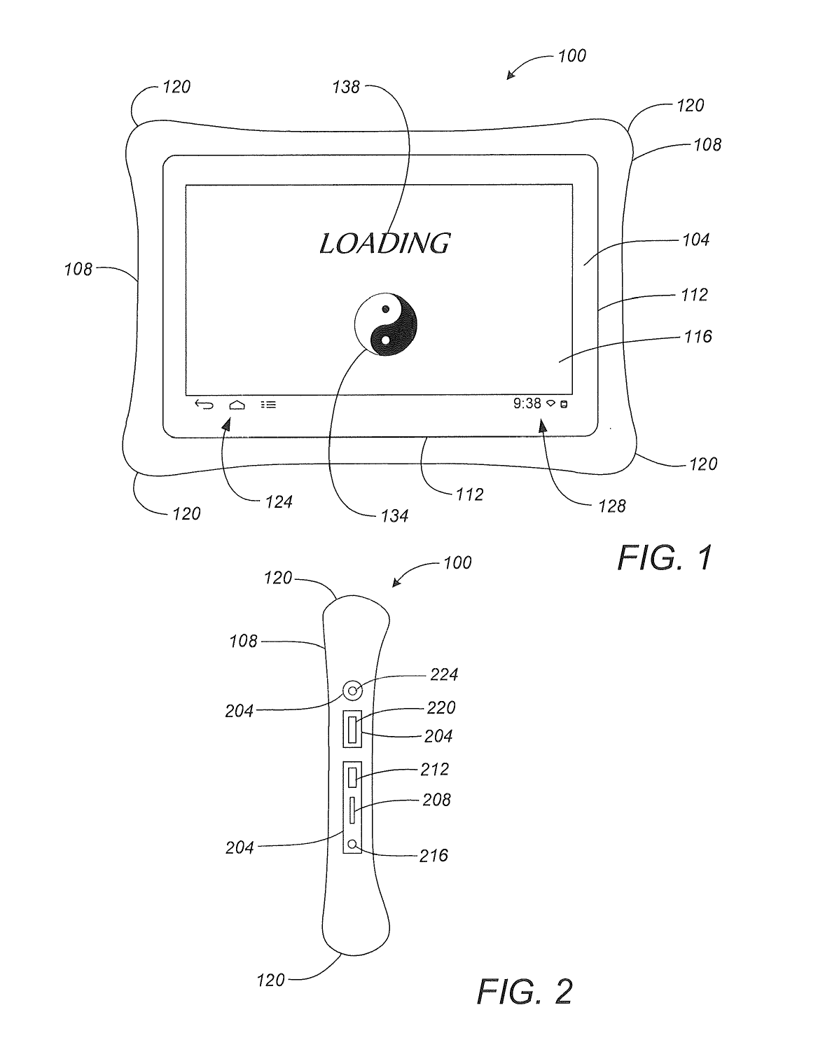

FIGS. 1-2 illustrate an exemplary embodiment of a tablet computer system 100 in accordance with the present invention. As best shown in FIG. 1, the tablet computer system 100 comprises a tablet computer 104, retained within an impact resistant protector 108. The protector 108 is comprised of a flexible material which may be placed onto the tablet computer 104 by an end-user such that the tablet computer 104 is protected from impacts due to being dropped or carried with other objects. The protector 108 includes an opening 112 which enables the end-user to view and interact with a touch screen 116 of the tablet computer 104. Corner regions 120 of the protector 108 prevent the tablet computer 104 from laying flat on a horizontal surface, such as a table top or a desk, so as to facilitate air cooling of the tablet computer 104. The corner regions 120 also provide additional protection to corners of the tablet computer, which tend to be particularly susceptible to damage when the tablet computer 104 is dropped. As illustrated in FIG. 2, the protector 108 comprises one or more openings 204 which provide access to port and slots on the exterior side of the tablet computer 104. Each opening 204 is shaped and sized to match a corresponding port or slot on the tablet computer 104. Markings may be applied to the outside of the protector 108 to indicate functions of each port or slot within the openings 204. Those skilled in the art will recognize that the openings 204 advantageously allow insertion of memory chips, plugs to peripheral devices, a tip of a stylus, and other similar devices, into the tablet computer 104.

In the exemplary embodiment illustrated in FIG. 1, the tablet computer 104 comprises the touch screen 116, one or more navigation controls 124, and one or more status indicators 128. The touch screen 116 preferably enables the end-user to view and interact with information displayed on the screen. In one embodiment, the touch screen 116 may be of the capacitive variety, which enables the end-user to operate the tablet computer 104 by touching the screen with a finger. In another embodiment, the touch screen 116 may enable the end-user to operate the tablet computer 104 by touching the screen with a stylus or other similar implement. It is envisioned that the tablet computer 104 comprises internal hardware, as well as suitable firmware, that supports the functionality of the touch screen 116. In an embodiment, the tablet computer 104 may comprise an NVIDIA Tegra processor, including a quad core with a 5th battery-saver core. Other suitable processors will be apparent to those skilled in the art without deviating from the scope of the present invention.

The navigation controls 124 enable the end-user to operate the tablet computer 104, in addition to software controls which may be displayed on the touch screen 116. Typical navigation controls 124 that are familiar to end-users may include, but are not necessarily limited to, a Back button, a Home button, and a Shortcut Menu button. Also familiar to many end-users are the status indicators 128, which may include, but are not necessarily limited to, a Clock, a WiFi Signal Strength indicator, and a Recycle Bin or Trash Can icon. It will be appreciated that a wide variety of symbols and functions may be used for, or associated with, the navigation controls 124 and the status indicators 128 without deviating from the scope of the invention.

As illustrated in FIG. 2, the tablet computer 104 comprises a card slot 208 which is suitably configured to receive an external storage card. In one embodiment, the card slot 208 may be configured to receive removable memory, such as a Micro Secure Digital (Micro SD) storage card. In another embodiment, the card slot 208 and the internal firmware may be configured to receive Micro SD cards having storage capacities ranging up to substantially 32 Gigabytes (GB), or greater. It is envisioned that the firmware and the card slot 208 may be configured to operate with other similar types of external storage cards having other storage capacities without deviating from the scope of the invention.

The tablet computer 104 further comprises a Micro Universal Serial Bus (USB) port 212 which is suitably configured to enable the end-user to connect the tablet computer 104 to an external computer by way of a USB cable. In one embodiment, the Micro USB connection may enable the end-user to install software applications from the tablet computer 104 onto the external computer. In another embodiment, the Micro USB connection may enable transferring photographs and video data files from the Micro SD card to the external computer. Moreover, the Micro USB connection may enable the tablet computer 104 to be powered by the external computer by way of the USB cable. It will be recognized that the Micro USB connection may be further utilized to charge an internal battery of the tablet computer 104 by way of power from the external computer or a power adapter which receives electrical power form a power outlet.

The tablet computer 104 further comprises a power adapter port 216 which is suitably configured to receive a power adapter cord which receives electrical power from a power outlet. In one embodiment, the power adapter port 216 may be configured to receive direct current (DC) at 5.0 volts (V) from the power adapter. In another embodiment, the power adapter may be configured to receive alternating current (AC) at between substantially 100V and 240V from the power outlet.

In the exemplary embodiment of FIGS. 1-2, the tablet computer 104 comprises a Mini High-Definition Multimedia Interface (HDMI) port 220. It will be appreciated by those skilled in the art that the Mini HDMI port 220 enables the end-user to connect the tablet computer 104 to external digital video devices, such as, by way of example, digital cameras, camcorders, and other similar digital devices possessing Mini-HDMI connectors. It is envisioned that the tablet computer 104 comprises internal firmware which supports connecting with external digital video devices, as well as working with photograph and video/audio data files. The data files may be formatted into popular file formats, such as, by of example, JPEG format for photograph files and MPEG-4 Part 14 (MP4) for video files. Digital audio data files may be formatted as MPEG-1 or MPEG-2 Audio Layer III (MP3) or Advanced Audio Coding (AAC) formats. In another embodiment, the firmware may support a video compression standard, such as, by way of example, H.263 or H.264 Video. Those skilled in the art will recognize that a wide variety of photograph and audio/video standards may be implemented without straying from the spirit and scope of the present invention.

The tablet computer 104 further comprises a headphone jack 224 which enables the end-user to plug in external headphone speakers. When external headphone speakers are plugged into the headphone jack 224, audible sounds that are otherwise played by way of the loudspeakers within the tablet computer 104 are instead played by way of the external headphone speakers. In an embodiment, the loudspeakers within the tablet computer 104 are disabled when the external headphone speakers are plugged into the headphone jack 224. In one embodiment, the headphone jack 224 is a 3.5 mm Standard Audio Jack. In another embodiment, the headphone jack 224 may be configured for use with external loudspeakers that are larger and/or more powerful than the loudspeakers within the tablet computer 104. A wide variety of uses, configurations, and alternative forms of the headphone jack 224 will be apparent to those skilled in the art without deviating from the present invention.

In the exemplary embodiment of FIG. 1, the touch screen 116 displays a transition screen 130 comprising a symbolic descriptor 134 and a text descriptor 138. It is envisioned that the tablet computer 104 may include software which includes a multiplicity of different transition screens 130 which may be displayed on the touch screen 116 at predetermined times, and for predetermined durations, so as to entertain or interest the end-user while other operations are performed by the tablet computer 104. In one embodiment, the multiplicity of transition screens 130 may comprise a software portion of the operating system of the tablet computer 104. In another embodiment, the multiplicity of transition screens 130 may comprise a software program which is installed, either by the end-user or a manufacturer of the computer, in addition to the operating system of the tablet computer 104. In still another embodiment, the multiplicity of transition screens 130 may be implemented as at least a portion of an internal hardware configuration of the tablet computer 104. Moreover, it is envisioned that the implementation of the transition screens 130 may include an option to disable the displaying of the transition screens 130. Disabling the transition screens 130 may be a manual setting controllable by the end-user, or may be system controlled so as to prevent the transition screens 130 from interfering with other software programs and operations, or to prevent the transition screens 130 from displaying during times when demand for resources is high, leading to delays or hesitations in the performance of the tablet computer. It will be appreciated by those of ordinary skill in the art that a wide variety of transition screens 130 may be implemented with the tablet computer 104 by way of various techniques without deviating from the spirit and scope of the present invention.

It is envisioned that the transition screens 130 will be not only interesting to the end-user, but also be contextual and convey information to the end-user about background operations being performed by the tablet computer 104 during the time the transition screen 130 is displayed. For example, the transition screen 130, as illustrated in FIG. 1, may indicate to the end-user that either the operating system of the tablet computer 104 is loading into a memory of the tablet computer 104 or a software program stored on the tablet computer 104 is loading into memory. Accordingly, as illustrated in FIG. 1, the text descriptor 138 displays the word “LOADING,” and the symbolic descriptor 134 is shown displayed on the touch screen 116. In another embodiment, the text descriptor 138 may display a farewell, such as, by way of example, “GOOD BYE,” when the operating system is shutting down and the tablet computer 104 is preparing to turn off. A wide variety of other suitable words or sentences for the text descriptor 138 will be apparent to those skilled in the art without deviating from the scope of the invention.

In an embodiment, the symbolic descriptor 134 may be a still image which is relevant to the background operations being performed by the tablet computer 104. For example, the symbolic descriptor 134 may be, but is not necessarily limited to, a logo, an image of a popular sports personality, a picture of a famous movie star, a cartoon character, or any other similar image suitable for displaying on the touch screen 130. Moreover, it is envisioned that the symbolic descriptor 134 and the text descriptor 138 share a common theme. For instance, in an embodiment wherein the symbolic descriptor 134 is a cartoon character, the text descriptor 138 may comprise popular slogans or comments that are associated with the cartoon character. Similarly, in an embodiment wherein the symbolic descriptor 134 is a movie actor, the text descriptor 138 may be well known sayings associated with the actor. It will be appreciated that a wide variety of different context-based transition screens 130 may be utilized with the tablet computer 104.

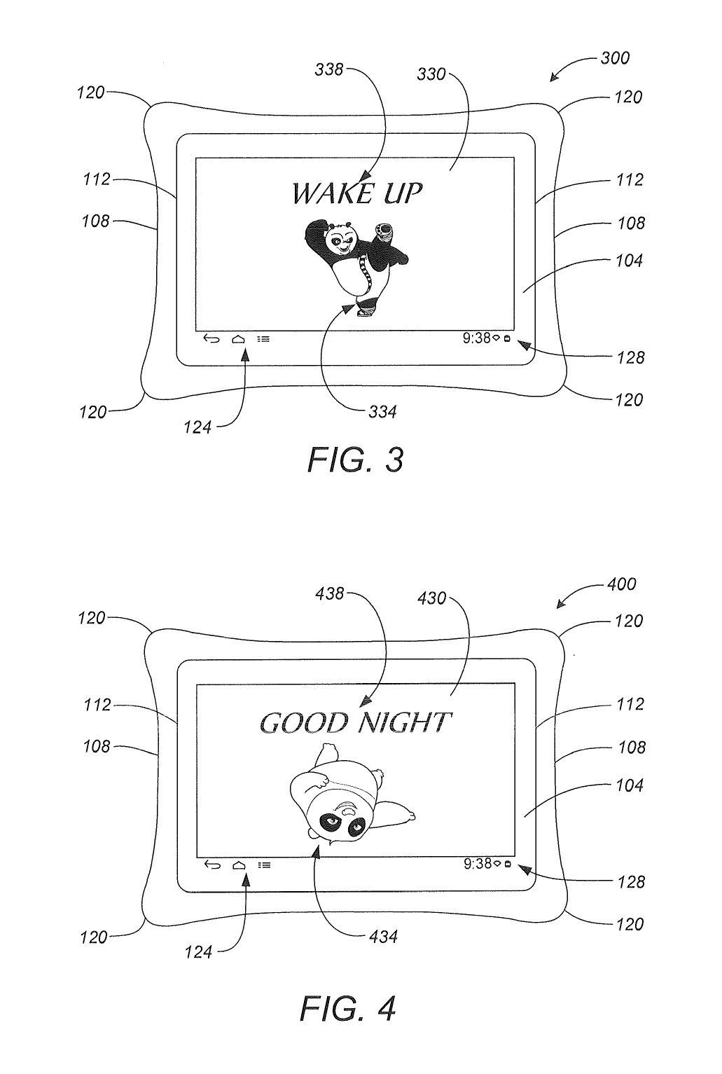

In an embodiment, the symbolic descriptor 134 may be an animated sequence which conveys interesting information to the end-user about the background operations being performed by the tablet computer 104. For example, in an embodiment illustrated in FIG. 3, a tablet computer system 300 intended for children of a specific age group comprises a touch screen 330 which includes a symbolic descriptor 334 and a text descriptor 338. In the illustrated embodiment of FIG. 3, the symbolic descriptor 334 is an animated sequence of a popular cartoon character performing a skit. The text descriptor 338 comprises relevant words to accompany the symbolic descriptor 334. In another embodiment, however, the text descriptor 338 may be animated in addition to the symbolic descriptor 334. For instance, in an embodiment, the text descriptor 338 may move around on the transition screen 330 according to the animated sequence comprising the symbolic descriptor 334. In other embodiments, the letters comprising the text descriptor 338 may change size, shape, color, order, orientation, or other similar attributes, according to the animation comprising the symbolic descriptor 334. It will be appreciated by those skilled in the art that an animated cartoon character and animated text advantageously serves to keep children interested in the tablet computer 104 during otherwise boring periods during which the tablet computer 300 performs background operations. Moreover, it should be understood that the transition screens 330 are not limited to conveying information about background operations of the tablet computer 104. Rather, the transition screens 330 may be used with programs other than the operating system, such as, by way of example, an Alarm Clock, in which embodiment, the symbolic descriptor 334 may show an animated character arising from sleep, and the text descriptor 338 may display “WAKE UP,” while an alarm is sounded by way of the loudspeakers of the tablet computer 104. In other embodiments, the tablet computer system 300 may be intended for adults, and the transition screens 330 may convey useful or interesting information, such as weather, traffic, news, jokes, comic strips, thought of the day, and the like.

It will be appreciated that audio may be advantageously included with the text and animations discussed above. In an exemplary embodiment illustrated in FIG. 4, a tablet computer system 400 targeted toward children of a specific age group comprises a transition screen 430 which includes a symbolic descriptor 434 and a text descriptor 438. In the illustrated embodiment, the symbolic descriptor 434 shows a popular cartoon character laying down, and the text descriptor 438 displays the words, “GOOD NIGHT.” Thus, the symbolic descriptor 434 and the text descriptor 438 share a common theme, both implying to children that it is time for sleep. As discussed above, the symbolic descriptor 434 and the text descriptor 438 may be animated sequences. In addition to the animations, however, it is envisioned that the tablet computer system 400 may also play audio soundtracks which share the common theme with the symbolic descriptor 434 and the text descriptor 438. For instance, in the illustrated embodiment of FIG. 4, a loudspeaker within the tablet computer system 400 may say the words, “GOOD NIGHT” at the same time that those words are displayed by the text descriptor 438. In another embodiment, the symbolic descriptor 434 and the loudspeaker may be synchronized such that the animated cartoon character appears to be saying the words played over the loudspeaker. It will be appreciated by those of ordinary skill in the art that there is an unlimited variety of audio/video content which may be suitably used with the transition screen 430 without straying beyond the spirit and scope of the present invention.

It will be appreciated that, in one embodiment, the software used to facilitate the transition screens discussed herein may be embodied onto a non-transitory machine-readable medium. A machine-readable medium includes any mechanism that stores information in a form readable by a machine (e.g., a computer). For example, a machine-readable medium includes read only memory (ROM); random access memory (RAM); magnetic disk storage media; optical storage media; flash memory devices; Digital VideoDisc (DVD's), EPROMs, EEPROMs, FLASH memory, magnetic or optical cards, or any type of media suitable for storing electronic instructions.

While some specific embodiments of the present invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

1. A tablet computer system, comprising:
a tablet computer comprising one or more navigation controls and a non-transitory machine-readable storage medium that stores instructions, which when executed by the machine causes the machine to perform operations according to the instructions;
an operating system comprising instructions that enable an end-user to interact with the operating system by way of the one or more navigation controls, wherein at least a portion of the operating system is stored on the non-transitory machine-readable storage medium;
at least one transition screen which is stored on the non-transitory machine-readable storage medium;
a display screen configured to display the at least one transition screen at predetermined times during operation of the tablet computer; and
one or more loudspeakers configured to play audio soundtracks at predetermined times during operation of the tablet computer.

2. The tablet computer system of claim 1, wherein the predetermined times are selected so as to entertain or interest the end-user while other operations are performed by the operating system.

3. The tablet computer system of claim 1, wherein the at least one transition screen comprises a software portion of the operating system.

4. The tablet computer system of claim 1, wherein the at least one transition screen comprises a software program which is installed onto the tablet computer in addition to the operating system.

5. The tablet computer system of claim 1, wherein the at least one transition screen is implemented as a portion of an internal hardware configuration of the tablet computer.

6. The tablet computer system of claim 1, wherein each of the at least one transition screen further comprises a symbolic descriptor configured to display symbolic imagery on the display screen and a text descriptor configured to display words on the display screen.

7. The tablet computer system of claim 6, wherein the symbolic descriptor is a still image which is relevant to background operations being performed by the operating system.

8. The tablet computer system of claim 7, wherein the symbolic descriptor is a logo, an image of a popular sports personality, a picture of a famous movie star, a cartoon character, or any other similar image suitable for displaying on the display screen.

9. The tablet computer system of claim 6, wherein the symbolic descriptor and the text descriptor share a common theme.

10. The tablet computer system of claim 9, wherein the symbolic descriptor is a cartoon character and the text descriptor comprises popular slogans or comments that are associated with the cartoon character.

11. The tablet computer system of claim 9, wherein the symbolic descriptor is a movie actor and the text descriptor comprises well known sayings associated with the actor.

12. The tablet computer system of claim 9, wherein the symbolic descriptor is an animated sequence which conveys information to the end-user in an interesting manner about the background operations being performed by the operating system.

13. The tablet computer system of claim 12, wherein the tablet computer system is designed for children of a specific age group, wherein the symbolic descriptor is an animated sequence of a popular cartoon character performing a skit, and wherein the text descriptor comprises relevant words to accompany the symbolic descriptor.

14. The tablet computer system of claim 12, wherein the text descriptor is animated in addition to the symbolic descriptor, and the text descriptor moves according to the animated sequence comprising the symbolic descriptor.

15. The tablet computer system of claim 14, wherein the letters comprising the text descriptor change size, shape, color, order, orientation, or other similar attributes, according to the animation comprising the symbolic descriptor.

16. The tablet computer system of claim 14, wherein the tablet computer system plays audio soundtracks, by way of the one or more loudspeakers, which shares the common theme with the symbolic descriptor and the text descriptor.

17. The tablet computer system of claim 16, wherein the symbolic descriptor and the one or more loudspeakers are synchronized such that the animated cartoon character appears to be saying the words played over the one or more loudspeakers.

18. A method of providing a tablet computer system to an end-user, comprising:
providing a tablet computer comprising one or more navigation controls and a non-transitory machine-readable storage medium that stores instructions, which when executed by the machine causes the machine to perform operations according to the instructions;
storing an operating system onto the non-transitory machine-readable storage medium, wherein the operating system contains instructions that enable the end-user to interact with the operating system by way of options provided by the operating system and by way of the one or more navigation controls;
storing at least one transition screen on the non-transitory machine-readable storage medium;
displaying the at least one transition screen on the display screen at predetermined times during operation of the tablet computer; and
configuring one or more loudspeakers to play audio soundtracks at predetermined times during operation of the tablet computer.

19. The method of providing a tablet computer of claim 18, wherein the at least one transition screen comprises a software portion of the operating system, or comprises a software program which is installed onto the tablet computer in addition to the operating system.

20. The method of providing a tablet computer of claim 18, further comprising configuring each of the at least one transition screens to display symbolic imagery and relevant words on the display screen, wherein the symbolic imagery and the words convey interesting information to the end-user while background operations are being performed by the operating system.
